(19) United States
(12) Patent Application Publication
(10) Pub. No.: US 2021/0295159 A1
(43) Pub. Date: Sep. 23, 2021

(54) DIGITAL COMPETITION SELF-VALIDATION USING MACHINE LEARNING

(71) Applicant: FirstBlood Technologies, Inc., Everett, MA (US)

(72) Inventor: Chuhao Zhou, Everett, MA (US)

(21) Appl. No.: 17/206,217

(22) Filed: Mar. 19, 2021

Related U.S. Application Data
(60) Provisional application No. 62/992,976, filed on Mar. 21, 2020.

(51) Int. Cl. G06N 3/08; G07F 17/32; H04L 9/06

(52) U.S. Cl. CPC G06N 3/08; G06K 9/6262; H04L 9/0637; G07F 17/3288

(57) ABSTRACT

Disclosed techniques enable arbitration of digital competitions based on self-validation using machine learning. A neural network is trained to recognize digital competition result images from a digital competition. A first computing device is used to subscribe a first and a second user group to a digital competition arbitration platform. A second computing device is used to execute a digital contract using a digital ledger token between groups, where the digital contract pertains to a result from the digital competition. The neural network is used to validate the result from the competition. The validating is based on reporting from the first user group and the second user group. The first user group submits an input image, such as a screenshot, of the result. The screenshot is accepted as self-validating based on a result from the neural network and the absence of a result being submitted from the second user group.

### RELATED APPLICATIONS

This application claims the benefit of U.S. provisional patent application “Digital Competition Self-Validation Using Machine Learning” Ser. No. 62/992,976, filed Mar. 21, 2020.

The foregoing application is hereby incorporated by reference in its entirety.

### FIELD OF ART

This application relates generally to digital competition arbitration and more particularly to digital competition self-validation using machine learning.

### BACKGROUND

Electronic games have been popular for nearly as long as the existence of digital computers. System operators, programmers, and users alike enjoy spending hours exploring imaginary worlds, slaying dragons, rescuing people, solving puzzles, finding clues, and much more. The earliest electronic games were text based or “teletype” games that included such classics as Dungeon™, Adventure™, and Zork™. The games were played by reading printed text and responding by typing in text. With the advent of video displays such as the Digital Equipment Corporation (DEC) VT-100™, the printer-based versions of the games quickly evolved into video versions. Players were able to read and enter text and see primitive video renderings of the virtual worlds described in the games. Electronic handheld versions of games also became popular. Early examples of such electronic games include Simon™ and Merlin™. These self-contained electronic games could be carried and played remotely by the users while away from a computer terminal.

Electronic games continued to evolve. With the widespread introduction of inexpensive digital hardware, powerful electronic games such as “arcade games” emerged. Games such as Pong™, Space Invaders™, and Pacman™ were widely played and enormously popular. Some of the arcade-style games were implemented with special hardware such as multiple CPUs, specialized audio, and video projectors. The games also used special input devices including steering wheels, dance mats, guns, fishing rods, and more. Other input devices have been added that closely resemble objects manipulated while playing the games. These devices include aircraft cockpits and automobiles, motorcycles, and animals, to name a few, which permit the user to more fully immerse herself or himself in the gaming experience. Other gaming innovations include computer or “PC” games and console games. PC games are played on a personal computer and include interactive video and audio. Console games have further advanced the gaming experience with special audio and visual effects. These latter games are typically played using a wide screen television or projector, and a multichannel audio system. More recent gaming innovations include the addition of headphones, microphones, and video goggles. The video goggles permit the game players to engage in augmented reality and virtual reality gaming scenarios.

Widely considered the most exciting innovation in electronic gaming is the online game. This classification of game is played over the Internet, wireless networks, or other networks, and allows multiple players to interact with each other within the game. The games are hosted on a game server or game site and can be played on personal computers, game consoles, and mobile devices. Many types of games can be played online including first-person shooter games, multiplayer games, strategy games, team games, role playing games, adventure games, and others. Some of the games include in-game purchases, hints, player enhancements, and more. The games are basic text-based games, video games, augmented reality (AR) games, and virtual reality (VR) games. The AR and VR games often include extensive graphics and audio tracks which together create substantial virtual worlds. Other games are based on social structures and merge the AR and VR worlds with the real-life communities of the players.

### SUMMARY

Disclosed techniques enable digital competition arbitration of competitive online games and eSports activities based on digital competition self-validation using machine learning. The digital competition arbitration platform supports competitive play among groups of online users and provides payouts of fees and winnings using a digital ledger currency. In order to compete in online games and eSports activities, users subscribe to a digital competition arbitration platform that oversees the digital competition. Users can include a first user group and a second user group, where the first user group can be a single user or a plurality of users, and the second user group can be a single user or a plurality of users. A digital contract between the first user group and the second user group is executed using a digital ledger token, where the digital contract pertains to a result from the digital competition. The first user group and the second user group remit payment by using digital ledger currency to execute the digital contract. The execution of the digital contract comprises a wager, an ante, an entrance fee, etc.

The first user group and the second user group engage in the digital competition. The result of the digital competition is validated by collecting input that is submitted from the first user group and input submitted from the second user group. The collected input includes an input image of the result of the competition. The input image can include a photograph or screenshot of the result, where the result can be displayed on a computing device used by the first group and a computing device used by the second group. The validating of the competition results includes self-validating using a neural network configured for machine learning. The screenshot that was taken on the device on which the digital competition for the first user group was performed can be accepted as self-validating based on a result from the neural network. The self-validation can further be based on the absence of a result being submitted from the second user group. Alternatively, the self-validating can be based on a result from the neural network that includes a result submitted by the second user group. The photograph or screenshot submitted by the first user group and/or the second user group contains specific digital competition result data for the first user group and the second user group. The specific digital competition result data can include one or more of digital competition identification, digital competition user group names, digital competition results, or digital competition result watermarks. The digital competition arbitration platform pays out compensation based on the digital contract. The payouts include winnings to the user group that does indeed win the competition, fees to the digital competition arbitration platform, and the like.

A computer-implemented method for digital competition arbitration is disclosed comprising: training a neural network to recognize digital competition result images from a digital competition; subscribing, using a first computing device, a first user group and a second user group to a digital competition arbitration platform that oversees the digital competition; executing, using a second computing device, a digital contract using a digital ledger token between the first user group and the second user group, wherein the digital contract pertains to a result from the digital competition; and validating, using the neural network that was trained, the result from the digital competition, wherein the validating is based on reporting from the first user group and the second user group. The reporting can include submitting an image of the competition result, where the image can include a photograph or screenshot. When the reporting includes a screenshot, the screenshot is taken on a device on which the digital competition for the first user group was performed. This screenshot is accepted as self-validating based on both a result from the neural network and the absence of a result being submitted from the second user group. Alternatively, the second user group may choose to submit a result that comprises a photograph or a screenshot. In this latter case, the screenshot that was taken on the device on which the digital competition for the first user group was performed is accepted as self-validating based on a result from the neural network that includes a result submitted from the second user group.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for digital competition validation using machine learning.

FIG. 2 is a flow diagram for self-reporting for validating.

FIG. 3 shows result screenshots on devices.

FIG. 4 is a block diagram illustrating match resolution.

FIG. 5 shows a blockchain.

FIG. 6A illustrates cypher block chaining encryption.

FIG. 6B illustrates cypher block chaining decryption.

FIG. 7 shows formation of a blockchain over time.

FIG. 8 is a flow diagram for transaction handling.

FIG. 9 shows a Merkle tree.

FIG. 10 illustrates proof of membership.

FIG. 11 shows a machine learning neural network.

FIG. 12 is a flow diagram for machine learning training.

FIG. 13 is a system diagram for digital competition validation.

### DETAILED DESCRIPTION

Digital competitive arbitration is the technique of determining a winner for an online, digital engagement. The competition arbitration can be determined without using a centralized, arbitration authority. Instead, the competition arbitration can be determined using a neural network that has been trained to recognize digital competition results within images. A digital engagement, or digital competition, can take the form of an electronic game such as an online game. An online digital competition can take many forms. In some instances, the competition can take the form of a sports or action game, commonly called eSports. A digital competition can involve a human participant against a game, a human participant against another human participant, or a plurality of human participants against another plurality of human participants. A digital competition can also include non-player characters, or NPCs. NPCs can be controlled by an algorithm within the game, can operate in a predetermined or responsive manner, etc. An NPC can be controlled by AI, and can be used to enhance the in-game experience of the human participants. A digital competition can further take the form of fantasy site games and major league prize pools. A digital competition can also assume the form of tournament pools, such as an NCAA basketball tournament prize pool. There are many such digital competitions for which determining a winner is a critical component.

The winner of a digital competition might receive an award or prize for winning the competition. Such compensation for the winner must be fairly and efficiently awarded in order to maintain the integrity of the digital competition. In all competitive situations, and especially in highly competitive digital engagements, the participant or team that is pronounced the winner must indeed be the valid winner. Unfortunately, as in many areas of life, there can be honest disagreement over the outcome of the event, but there can even be dishonest disagreement. The potential exists for unintentional mistakes or even cheating to take place in a competitive event. In national societal events that have hundreds of years of history, such as the quadrennial United States presidential election, the certification of, or if need be, the arbitration of, the correct or valid winner can be complicated. Certification or arbitration of a digital competition is likewise complicated, demanding an effective means to arbitrate the outcome in a fair, efficient, and satisfying manner.

In many societies, arbitration of judicial complaints, or in a manner of speaking, “judicial competitions”, are performed via the agencies of witnesses and jury. Yet many examples exist in which a jury got the decision spectacularly wrong. Jurors can be bought and blackmailed; juror biases, whether overt or covert, can blind the jury; and so on. To address these adjudication deficiencies, the validation of a decision, such as deciding the winner of a digital competition, can be determined based on input provided by a neural network. The neural network, which can be configured for machine learning, can be part of an arbitration platform which can determine outcomes of various types of online competitions. The neural network can be configured by training the network to identify and evaluate contents of images submitted from a digital competition. The arbitration platform allows a first user group and a second user group to subscribe, where subscription enables the user groups to compete in a digital competition. The arbitration platform further executes a digital contract using a digital ledger token. The digital ledger can be based on a blockchain. The digital contract is executed to oversee the digital competition. The result of the digital competition is self-validated based on results provided by the neural network. The neural network receives images showing the results of the digital competition. The neural network analyzes the images for digital competition result data, where the result data can include a competition ID, user group names, competition results, result watermarks, and so on.

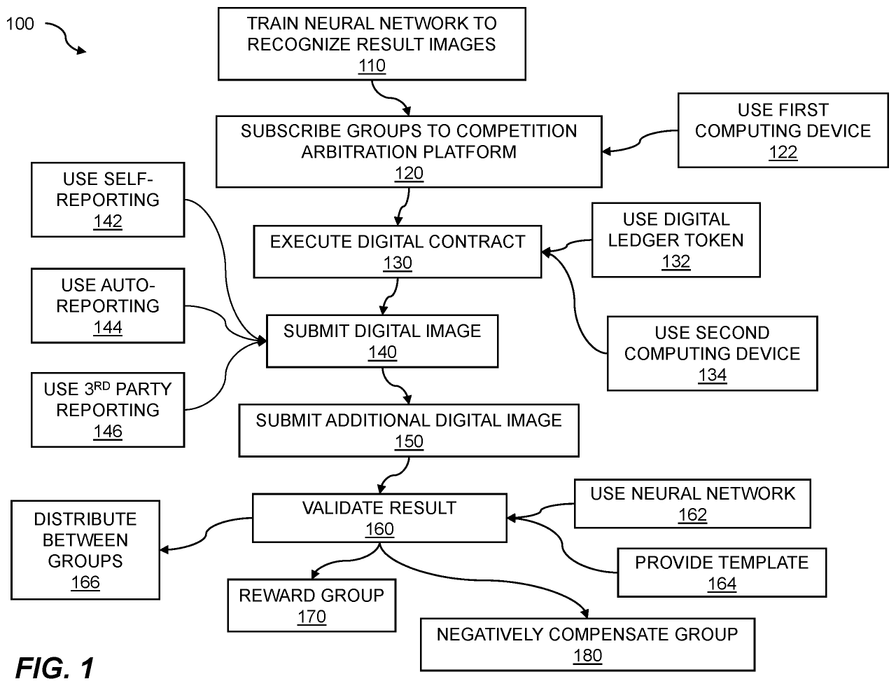

FIG. 1 is a flow diagram for digital competition self-validation using machine learning. Machine learning, which is based on training a network, such as a neural network, to make inferences based on data, can adjudicate competition outcomes quickly and without human errors or biases. The digital competition self-validation enables digital competition arbitration. The digital competition arbitration comprises a digital competition arbitration platform that oversees a digital competition, where the arbitration platform can include the neural network trained to perform digital result validation and arbitration. The digital competition can be an eSports game, such as League of Legends™ or Dota 2™, to name just two. The digital competition can be referred to as a match. The digital competition can comprise an online game, a massively multiplayer online role-playing game (MMORPG or MMO), etc. The digital competition can comprise an eSports activity. The flow 100 includes training a neural network to recognize digital competition result images 110 from a digital competition. The neural network includes layers of nodes or neurons. The neurons can process data, where the processing of the data can be manipulated by adjusting weights or biases associated with the neurons. The training of the neural network includes adjusting weights associated with the neurons. The training of the neural network can be accomplished using supervised, semi-supervised, or unsupervised techniques. In embodiments, the neural network comprises a machine learning system.

The flow 100 can include subscribing a first user group and a second user group to a digital competition arbitration platform 120 that oversees the digital competition. The digital arbitration platform can provide a neural network-based infrastructure for validation and arbitration of a match between users. The digital competition can occur on a digital platform which is separate from the digital competition arbitration platform. The digital competition arbitration platform can be decentralized. In the flow 100, the subscribing can include using a first computing device 122. The first computing device can include a desktop or gaming computer, a laptop computer, a gaming console, a tablet, a smartphone, a personal digital assistant (PDA), and so on. The first computing device can include a matchmaking server. In embodiments, the matchmaking server can be located within a system for digital competition. The subscribing to an arbitration platform 120 can comprise one or more subscriptions. The subscriptions can be for a first user group and a second user group. The user groups can be comprised of an individual or a plurality of individuals or a combination of both. The first user group can comprise a single user. The first user group can comprise a plurality of users. The second user group can comprise a single user. The second user group can comprise a plurality of users.

The flow 100 can include executing a digital contract 130. The digital contract can include a contract comprising a competition between the first user group and the second user group. In the flow 100, the executing the digital contract can include using a digital ledger token 132. The digital ledger token can comprise a digital ledger currency. The digital ledger token can be referred to as a medium of exchange. The digital ledger token can comprise a plurality of individual tokens. The digital ledger token can comprise cryptocurrency. The digital currency can comprise Ethereum™ digital currency, which allows for the creation of digital smart contracts. Other digital currencies, such as Bitcoin™, can also be employed. The digital ledger token can comprise blockchain technology. The digital contract that was executed can provide a platform, or framework, with which to oversee digital competition. The digital contract can comprise a smart contract, where the smart contract can comprise a wager, a bet, an ante, and so on. The digital contract can be maintained using blockchain technology. The data associated with the digital contract can be maintained using blockchain technology. The executing a digital contract can be accomplished using a second computing device 134. In embodiments, the digital contract that is executed can comprise a digital ledger transaction that requests the result of a digital competition between a first user group and a second user group. In some embodiments, the digital ledger transaction can be accomplished on a single digital device or using multiple devices. The digital ledger transaction can include a decentralized system for digital competition result validation and arbitration. In embodiments, the digital ledger transaction can include receiving results from the neural network. The first computing device and the second computing device can be a device in common. In some embodiments, the second computing device is an arbitration server, where the arbitration server can facilitate matchmaking between the first user group and the second user group.

The flow 100 can include the first user group submitting a digital input image 140 of the result. The result can include one or more results or outcomes of a digital competition. The input image can be captured from a computing device with which the first user group participated in the digital competition. In embodiments, the input image can include a photograph of the result. The photograph can be captured using a digital camera or other image capture device, where the camera can be associated with the first computing device discussed previously, with a camera coupled to personal electronic device associated with the first user group, and so on. In other embodiments, the input image can include a screenshot of the result. The screenshot can be captured using menu selection, a keyboard shortcut, etc. The screenshot can comprise a photograph taken of the screen on another device or camera. In embodiments, the screenshot is taken on a device on which the digital competition for the first user group was performed. The digital image submission can be accomplished using self-reporting 142 of the result, as described above and below. The digital image submission can be accomplished using automatic reporting 144. A game user interface (UI) or application programming interface (API) for the digital competition can be reverse-engineered such that a script running in the background can automatically tell when a button needs to be pushed. This approach allows automatic hosting of the digital competition and automatic reporting of a result of the digital competition. The digital image submission can be accomplished using third-party reporting 146. A third party, that is, a person or persons not involved as a member of the first user group or the second user group, can be designated to provide the result digital image. For example, a spectator could snap a photograph of an arm wrestling competition and upload it as result validation recognized by machine learning. In embodiments, the reporting from the first user group and the second user group comprises self-reporting. In embodiments, the reporting from the first user group and the second user group is accomplished using reporting from a third party. And in embodiments, the validating is accomplished using automatic recognition of a user interface provided by the digital competition.

The flow 100 can include the second user group submitting an additional digital input image 150 of the result. The additional input image can include a photograph of the result captured using a digital camera or image capture device. In embodiments, the additional input image comprises an additional screenshot of the result. The additional screenshot can be taken on a device on which the digital competition for the second user group was performed. The device on which the digital competition for the second user group was performed can be the same device as the device on which the digital competition for the first user group was performed.

The flow 100 can include validating the result 160 from the digital competition. The first user group and the second user group can compete until the competition has been completed. The completion of the competition can include one user group defeating the other user group, scoring more points, solving more puzzles, collecting more treasure, and so on. The validating the result can be accomplished using a neural network 162. The neural network can include the neural network trained to recognize digital competition results. In embodiments, the validating is based on self-reporting from the first user group and the second user group. The self-reporting by the first user group and the second user group can include submitting images or screenshots, submitting additional images or additional screenshots, and so on. The validation can include collecting the input images from the first user group, collecting additional input images from the second user group, and so on. The types of result images or screenshots that can be considered acceptable for digital competition arbitration can be based on criteria, parameters, specifications, and so on. Further embodiments include providing a template 164 to at least the first user group to enable the validating. The template can be used for submitting a result screenshot or photograph. While two user groups are discussed here, in embodiments, the validating can be distributed between or among two or more user groups 166.

Another method can be used to perform validation of results of a digital competition such as using validating devices. In embodiments, the device on which the digital competition for the first user group was performed can be validated based on the digital ledger. Validation based on the digital ledger can ensure that a submitted photograph or a screenshot indeed originated from the machine on which the competition occurred. Validation can be based on a presence or a lack of evidence submitted from the user groups that participated in the digital competition. In embodiments, the screenshot that was taken on the device on which the digital competition for the first user group was performed can be accepted as self-validating based on both a result from the neural network and the absence of a result being submitted from the second user group. That is, the second user group can choose not to contest the competition result, or can simply refrain from submitting a photograph or screenshot. In other embodiments, the screenshot that was taken on the device on which the digital competition for the first user group was performed can be accepted as self-validating based on a result from the neural network that includes a result submitted from the second user group. In this usage example, the second user group may choose to challenge the competition result, may decide to submit an image to further confirm the competition result, and the like.

In embodiments, the screenshot that can be submitted to validate the competition result can include specific digital competition result data for the first user group and the second user group. The digital competition result data can show a score, a result, an elapsed time, and so on. In embodiments, the specific digital competition result data can include one or more of digital competition identification, digital competition user group names, digital competition results, or digital competition result watermarks. The digital competition result watermarks can include watermarks visible or invisible to the human eye. The digital competition result watermarks can include steganographic watermarks. Various rewards, prizes, compensations, demerits, etc., can be provided to a user group. The amount of a prize, for example, can be based on an amount approved in the digital contract. The user groups can further be compensated positively or negatively based on a timely response at the conclusion of a competition. The flow 100 further includes rewarding a user group 170 that first submits the result for the digital competition. Such a reward can be used to encourage a speedy conclusion to a competition, particularly when the competition is part of a larger tournament, digital competition event, and so on. The flow 100 further includes negatively compensating a user group 180 in the absence of submitting the result for the digital competition. Such negative compensation can be used to encourage good sportsmanship, to speed resolution when the competition results are contested, etc.

The flow 100 can include a computer-implemented method for digital competition arbitration comprising: training a neural network to recognize digital competition result images from a digital competition; subscribing, using a first computing device, a first user group and a second user group to a digital competition arbitration platform that oversees the digital competition; executing, using a second computing device, a digital contract using a digital ledger token between the first user group and the second user group, wherein the digital contract pertains to a result from the digital competition; and validating, using the neural network, the result from the digital competition. The training, the subscribing, the executing, and the validating can each be performed by one or more processors and/or one or more computing devices. The training, the subscribing, the executing, and the validating can each be performed by the same one or more processors or different one or more processors. In embodiments, a computer program product is embodied in a non-transitory computer readable medium for digital competition arbitration, the computer program product comprising code which causes one or more processors to perform operations of: training a neural network to recognize digital competition result images from a digital competition; subscribing, using a first computing device, a first user group and a second user group to a digital competition arbitration platform that oversees the digital competition; executing, using a second computing device, a digital contract using a digital ledger token between the first user group and the second user group, wherein the digital contract pertains to a result from the digital competition; and validating, using the neural network, the result from the digital competition.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

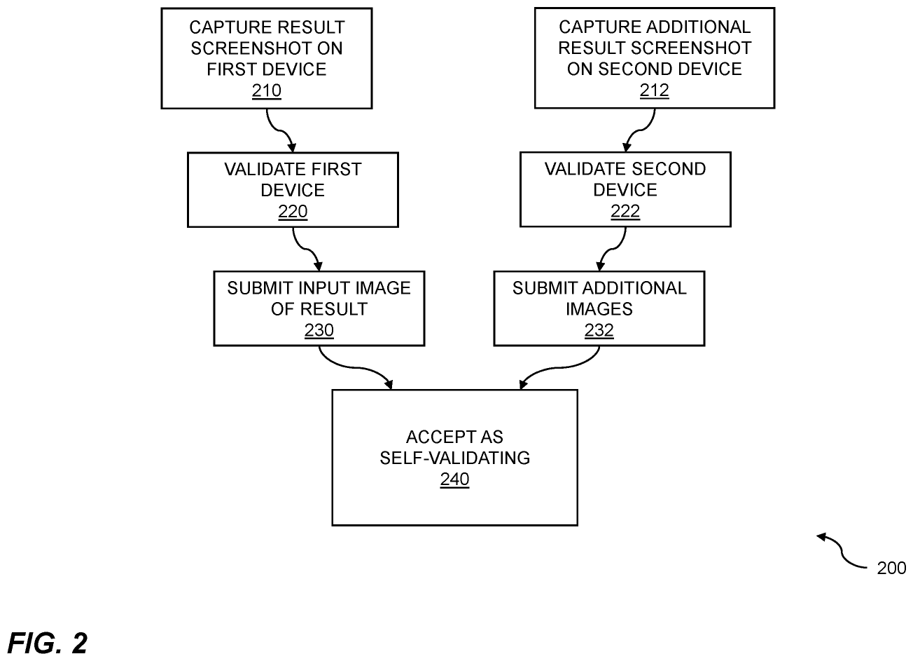

FIG. 2 is a flow diagram for self-reporting for validating. The self-reporting can be based on providing results of a digital competition between two groups to a digital competition arbitration platform. The results that are provided can be analyzed using a neural network trained to recognize digital competition results. The neural network examines the provided results for specific digital competition result data such as IDs, names, results, watermarks, and so on. The self-reporting enables digital competition self-validation using machine learning. The flow 200 includes the first user group capturing a result screenshot on a first device 210. The screenshot can be taken on a device on which the digital competition for the first user group was performed. The first device can include a computing device such as a laptop, a tablet, a smartphone, and so on. The first device can include a gaming device, a server, etc. The screenshot can include a photograph of the screen, an image of the screen, and so on. The flow 200 includes the second user group capturing an additional input image of the result on a second device 212. The additional screenshot can be taken on a device on which the digital competition for the second user group was performed. The additional input image can include a screenshot, a photograph, etc. The additional input image that can be captured comprises an additional screenshot of the result.

In the flow 200, the device on which the digital competition for the first user group was performed is validated 220 based on the digital ledger. The validation of the device can include verifying that the device from which the result image is provided is indeed the device on which the competition was played. The validating can be based on a digital ledger token, a unique value associated with the device such as a MAC address or other hardware value, and so on. In the flow 200, the device on which the digital competition for the second user group was performed is validated 222 based on the digital ledger. Again, the validation can be based on a digital ledger token, a unique identifier, and the like.

The flow 200 includes the first user group submitting an input image of the result 230. The input image, which can include a photograph of the result, a screenshot of the result, and so on, can be submitted over a computer network, a cellular network, or other network. The submitting can be based on a template provided to at least the first user group. The flow 200 includes the second user group submitting an additional input image of the result 232. More than one additional image can be submitted. The flow 200 includes accepting a screenshot as self-validating 240. The self-validating can be based on one or more screenshots, where the one or more screenshots can be provided by the first user group, the second user group, or both user groups. In embodiments, the screenshot that was taken on the device on which the digital competition for the first user group was performed can be accepted as self-validating based on both a result from the neural network and the absence of a result being submitted from the second user group. Such acceptance as self-validating can be based on the neural network confirming or validating the competition result and no contesting of the results from the second user group. In other embodiments, the screenshot that was taken on the device on which the digital competition for the first user group was performed can be accepted as self-validating based on a result from the neural network that includes a result submitted from the second user group. The result submitted by the second user group can be used to confirm the result of the first group or to contest the result. The results from the neural network can confirm or validate contest results by confirming screenshots of competition results, rejecting screenshots of competition results, etc.

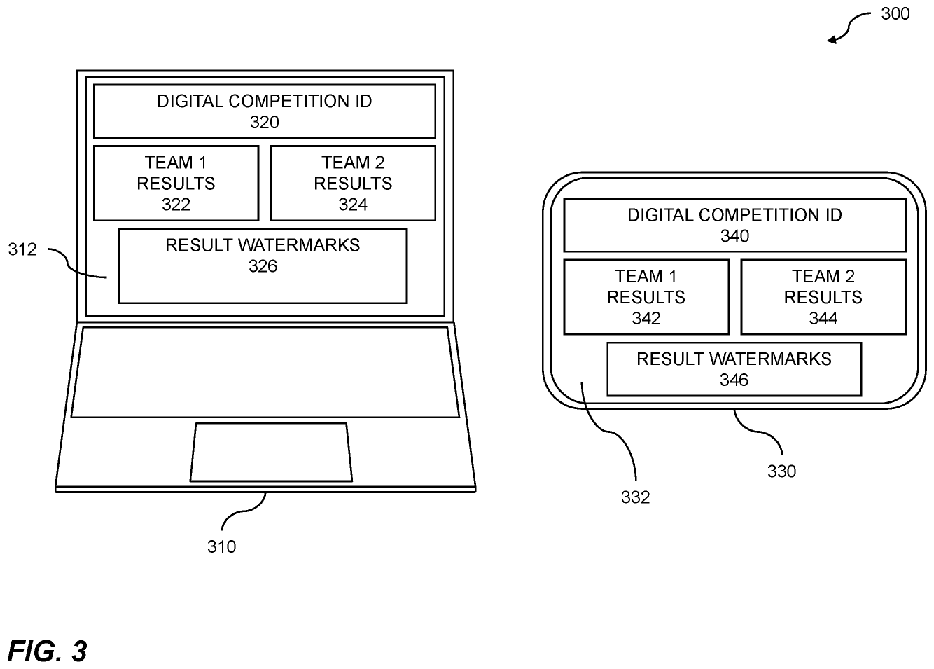

FIG. 3 shows result screenshots on devices. Discussed throughout, digital competition arbitration can include digital competition self-validation using machine learning. A digital competition can be undertaken between a first user group and a second user group. The first user group and the second user group can self-report digital competition results, and a neural network can be used to validate the self-reported results. The self-reporting can include submitting an input image of the result of the competition. The input image can include a photograph of the result, a screenshot of the result, and so on. The screenshot or photograph can be accepted as self-validating based on a result from the neural network. A neural network is trained to recognize digital competition result images from a digital competition. A first computing device is used to subscribe a first user group and a second user group to a digital competition arbitration platform that oversees the digital competition. A second computing device is used to execute a digital contract using a digital ledger token between the first user group and the second user group. The digital contract pertains to a result from the digital competition. The neural network is used to validate the result from the digital competition.

Results of digital competitions, such as online digital competitions, can be rendered on displays. The displays can include televisions, projectors, and so on. The displays can include displays associated with various types of computing devices 300. In embodiments, the computing device can include a laptop computer 310. The laptop computer can include a display 312 on which a digital competition, such as an online digital competition, can be played. At the ending, completion, termination, etc. of the digital competition, result data associated with the competition can be rendered on the display 312. Various contents can be rendered on the display. In embodiments, specific digital competition result data can include one or more of digital competition identification 320, digital competition user group names, digital competition results such as team 1 results 322 and team 2 results 324, or digital competition result watermarks 326. A photograph or screenshot of the display associated with the laptop computer 310 can be captured and submitted or self-reported for digital competition arbitration by a neural network. In other embodiments, the computing device can include a tablet 330, smartphone, personal digital assistant (PDA), and so on. A display 332 associated with the tablet 330 can be used to render results of the digital competition. In embodiments, the specific digital competition result data can include one or more of digital competition identification 340, digital competition user group names, digital competition results such as team 1 results 342 and team 2 results 344, or digital competition result watermarks 346. A photograph or screenshot can be captured and submitted or self-reported for digital competition arbitration by a neural network.

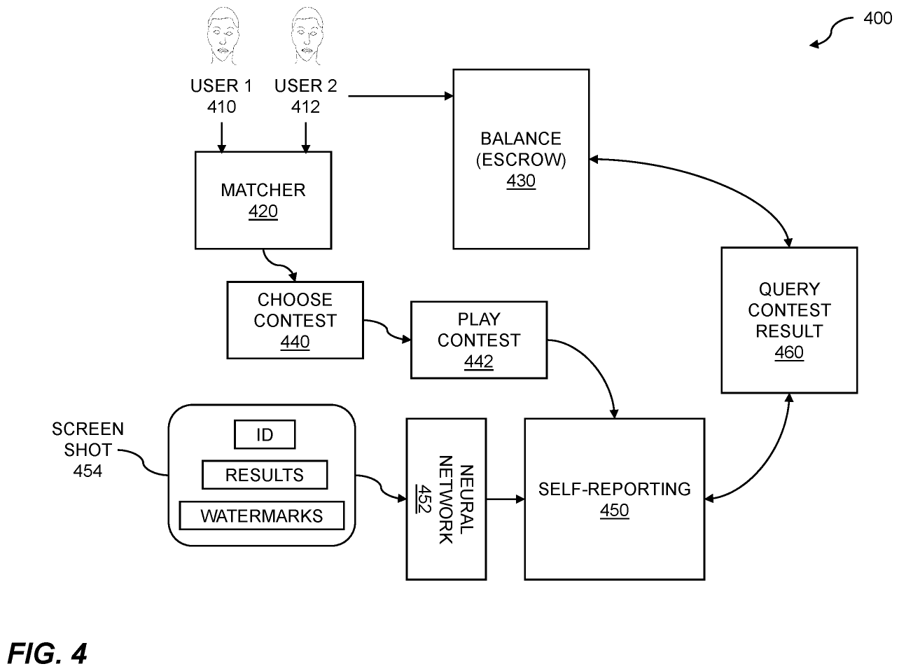

FIG. 4 is a block diagram illustrating match resolution. Contestants can compete against one another in a variety of online contests such as eSports, multiplayer games, strategy games, competitions, and so on. When no funds are transferred from the loser to the winner of a contest, the winner may be determined amicably by the contestants in a spirit of mutual agreement. In the event that the contestants disagree, there is a wager involved, verification is required for payout, or in other cases that require arbitration, digital competition arbitration can be accomplished using a neural network. The neural network can be trained to perform the arbitration tasks. The trained neural network enables digital competition self-validation using machine learning. A neural network is trained to recognize digital competition result images from a digital competition. A first user group and a second user group are subscribed to a digital competition arbitration platform that oversees the digital competition. A digital contract is executed using a digital ledger token between the first user group and the second user group, where the digital contract pertains to a result from the digital competition. The neural network is used to validate the result from the digital competition.

The gaming world has moved online. The eSports, multiplayer games, strategy games, persistent world games, or other online competitions can be played in a variety of ways, including individual play, team play, cooperative play, strategic play, in-game purchase play, and so on. The techniques by which individuals participate in the contests or competitions can include participation as individual players, teams of players, or alliances of players. The contests between individuals can be entered as described above. An individual can pay a fee, place a wager, transfer funds or tokens into an escrow account, agree to compete, etc. Similarly, players can form teams prior to entering a contest, form in-game teams and alliances, and so on. Whether playing as individuals or as teams, the contestants vie to win real-time strategy games, battle games, first-person shooter games, or fighting games that can include battlefields, boxing rings, or mixed martial arts cages. The fees, wagers, or prizes can be transferred to the winner or winners based on self-validation using machine learning. When the contestants agree on which individual or team is the winner, or a neural network confirms a winner, then the transfer can take place.

In one usage scenario in which the contestants compete, the game or competition can include two or more individuals or teams playing between and among each other to determine an overall winner. Such games or competitions can include a winner-take-all victory, a round-robin tournament, a “bataille royale” (battle royal) contest, a massively multiplayer online game (MMOG or MMO) competition, persistent play games which can be exited and re-entered, and so on. In this scenario, individuals or teams enter to compete by paying a fee, placing a wager, transferring funds/tokens, and the like. The games or completions can include a plurality of players such as tens, hundreds, or more players, who can compete individually or as teams. The competitions can include one-on-one games, contests, battles, etc.; heats or preliminary rounds; a tournament tree; qualifying rounds; and the like. The game or competition can include quarterfinal rounds, semifinal rounds, a final round, and so on. The game or competition can include solving puzzles, earning points by finding treasure, etc. The game or competition can continue as some of the participants or teams are defeated, cut, disqualified, retired, or are otherwise removed from the game or competition. The end of the game or competition can be determined by an overall winner. The winner can be the individual or team that has amassed the most points, won the most battles, solved the most puzzles, located the most treasure, and so on. The winner can be the “last person standing”, last team participating, etc. The overall winner can be determined by agreement by the participants, or when no agreement can be reached, by validation using a trained neural network. The winner can be awarded money or tokens, a prize, fame and glory, or the like. Money or tokens can be transferred to the winning individual or team. In embodiments, prizes, winnings, etc., can be awarded based on a ranking of finishers of the game or competition. A ranked finish can include first place, second place, third place, runner up, a consolation prize, and so on. In some cases, the first user group and the second user group are part of a multiplicity of user groups involved in the digital competition. In embodiments, the multiplicity of user groups competes in a round-robin type competition. In other embodiments, the multiplicity of user groups is matched by an arbitration server.

An example block diagram 400 for match resolution is shown. Contestants such as user 1 410 and user 2 412 can register to compete in online competitions. While two users are shown, tens, hundreds, thousands, etc., of contestants can register for one or more online competitions. The registration can include information such as contact information, an online persona, competition preferences, payment details, a digital wallet address, and so on. The online competitions can be “friendly” contests where points or other indications of victories can be recorded, competitions which pay out prizes, wager-based competitions, etc. A matcher 420 can match users who have registered to compete in online competitions. The matcher can serve as a “matchmaker” that identifies users with similar interests, rankings, abilities, histories, or other parameters that can be identified and ranked. When contestants such as user 1 and user 2 are matched, they can agree to compete. Entry into the competition can require payment of a fee, an ante into a kitty, a wager, and so on. The payment can be added to a balance and held in escrow 430. The escrow can act as a bank that holds the fees, antes, wagers, etc. Tokens such as Tether™, DollarFirst™, etc., can be issued based on the funds held in escrow. The contestants can choose a contest 440. The contest can include an online competition such as a battling game, a head-to-head competition, skills-based contests, problem solving challenges, eSports, and so on.

The contestants can compete by playing the agreed upon contest 442. The players compete until one is victorious over the other by defeating the other player, finding more treasure, earning more points, taking less time to complete a task, solving more puzzles, or some other basis for determining a winner of the contest. The players can agree as to which player is the victor or can request arbitration such as digital arbitration. Digital arbitration can be required when a prize, winnings, etc., are to be paid out, irrespective of whether the contestants agree on the victor or not. The digital arbitration can be based on self-reporting 450. The digital arbitration can verify the outcome of the contest by using a trained neural network 452 to assess contents of a screen showing results of the competition. A photograph or screenshot 454 of the contest result can be self-reported by the first user group and the second user group. The photograph or screenshot can be assessed by the neural network and can be accepted as self-validating based on a result from the neural network. The self-validating can be based on accepting and evaluating a photograph or screenshot from the first user group, the second user group, or both. The neural network examines the screenshot for various contents that can be used to validate the outcome of the digital competition. The neural network can examine the photograph or screenshot for specific digital competition results data for the first user group and the second user group. In embodiments, the digital competition results data can include one or more of digital competition identification, digital competition user group names, digital competition results, or digital competition result watermarks. When a contest is decided or a prize is to be awarded, or wagers or a “kitty” paid out, and so on, a query of the contest result 460 can be initiated. The result of the query can be verification of which contestant is the winner of the contest. When the winner has been verified, the balance held in escrow 430 can be paid out to the winner such as user 1, user 2, etc.

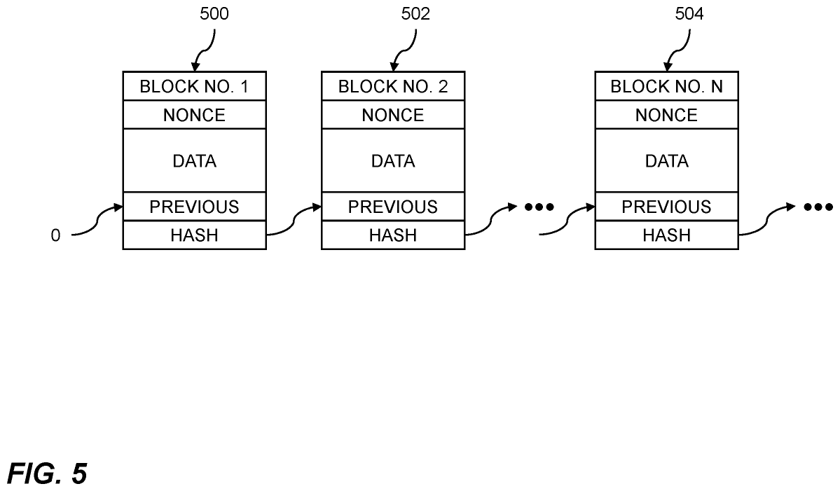

FIG. 5 shows a blockchain. Online transactions, such as online transactions associated with digital competition, can be secured by using a blockchain. A blockchain is a digital ledger that supports the recording of the digital transactions. The blockchain records the online transactions as a decentralized, widely distributed, digital ledger. The registered transactions are hashed and stored such that the transactions cannot be altered, modified, changed, corrupted, tampered with, etc., after the transactions have been recorded, thus securing the registered transactions. A neural network is trained to recognize digital competition result images from a digital competition. A first computing device is used to subscribe a first user group and a second user group to a digital competition arbitration platform that oversees the digital competition. A second computing device is used to execute a digital contract using a digital ledger token between the first user group and the second user group, where the digital contract pertains to a result from the digital competition. The neural network is used to validate the result from the digital competition. The validating can be based on a submitted input image of the result, where the input image can include a photograph or screenshot.

A blockchain can include two types of records. The blockchain records can include blocks and transactions. A block can include transactions, where the transactions have been determined to be valid. The blocks can be organized into a Merkle tree, which will be discussed in greater detail later. The Merkle tree can be formed based on hashing the transactions and on encoding the hashed transactions. A block in the blockchain includes a hash of the previous block in the blockchain. A blockchain can resemble a linked list in that the blocks of the chain are linked together. The notable difference between a linked list and a blockchain is that the reference to the previous block is not a pointer, but instead a hash. Adding blocks to the blockchain is an iterative technique. The hash of the current block depends on the hash of the previous block, the hash of the previous block in the chain depends on the hash of the previous block to that block, and so on. A result of the iterative technique of the blockchain is that data stored in a blockchain can be considered secure. An example of security of data stored in a blockchain is digital currency. Since each block in a blockchain depends on hashes that are based on previous blocks in the blockchain, then a change of data in one block of the blockchain invalidates the hashes of all subsequent blocks in the blockchain. Digital currency can be spent once and cannot be infinitely reproduced and/or spent. That is, a transaction that shows that a particular unit of digital currency was used in an exchange creates a hash. If the unit of digital currency were to be used again, then the hash generated by the new transaction would invalidate all subsequent blocks in the blockchain, indicating that an attempt was made to reuse the unit of digital currency.

At times, validation can occur concurrently for separate blocks. The result of concurrent validation can be to create a fork, where the fork can remain temporarily. Recall that the blockchain is a distributed digital ledger that can be distributed widely across computer systems. The temporary fork can result in multiple histories of the blockchain since updates to the blockchain might not have completely disseminated across the distributed digital ledger. Algorithms, code segments, apps, applications, programs, etc. can be used to score the various versions of the history of the blockchain. Versions of history of the blockchain with the highest score can be chosen over versions of the history of the blockchain with lower scores. The lower scored versions of the history might not be selected for inclusion in the blockchain. The versions that are not selected for inclusion are called orphan blocks. Decisions about which histories of the blockchain score the highest are determined by peers in the distributed digital ledger. The peers use a particular algorithm, code segment, etc. to determine the scoring.

Updates to the blockchain are distributed across the peers. A peer can receive a version of the history of the blockchain with a higher score. The higher score can occur when a block is added to the blockchain. The peer can add the new block to the version of the blockchain stored by the peer, overwrite the existing version of the blockchain, etc. A new score can be determined. The peer can retransmit the improved blockchain to their peers.

In FIG. 5, a blockchain is shown. The blockchain includes blocks 500, 502, and 504. While three blocks are shown, in practice any number of blocks can be included in the blockchain. In practice, the number of blocks in the blockchain continues to increase. A block such as the block 500 includes a block number, a nonce, data, a hash received from the previous block, and a hash generated for this block. Since the block 1 500 is the first block in the blockchain, there is no previous block. For this first block of the blockchain, the hash from the previous block is zero. The nonce is a value that is a “onetime” value determined for the block. The nonce is a value that is determined based on the data, the previous hash, the hash for the current block, etc. If any information in the block were to be changed, such as the data, the previous hash, the block hash, etc., then the nonce value is no longer valid for the block. The nonce can be used to indicate that the block has been tampered with, corrupted, or otherwise changed. If there is a valid reason to change a value in the block, such as updating the data in the block, then a new nonce value is calculated. Determination of the new nonce value can be based on the hash for the block or other criteria. Subsequent blocks in the blockchain, such as the block 2 502 and the block N 504, contain fields similar to those fields of the first block 500. The previous hash value of the block 502 is set to the hash value of the block 500. The previous hash value of the block 504, block N, is set to the hash value for a block N−1 (not shown).

A change of value in one block of a blockchain causes the validity of all subsequent blocks to be negated. The invalidity of all subsequent blocks results from the hash of a given block being dependent on the hash of a previous block. That is, even though data in a given block such as the block 502 has not changed, the validity of the block 502 was based on the validity of its previous block, 500. If the data in the block 500 were to be changed, and the nonce not updated, then the block 502 is no longer valid since the hash for the block 500 changes. Since the validity of a given block depends on the validity of previous blocks, then the block 504 becomes invalid, and so on. By looking at any block in the blockchain, it can be determined whether the data in that block is valid. If the data in the block 500 were changed legitimately, then a new nonce value can be generated to revalidate the block 500. The result of regenerating the nonce value for the block 500 is that all subsequent blocks in the blockchain can remain valid.

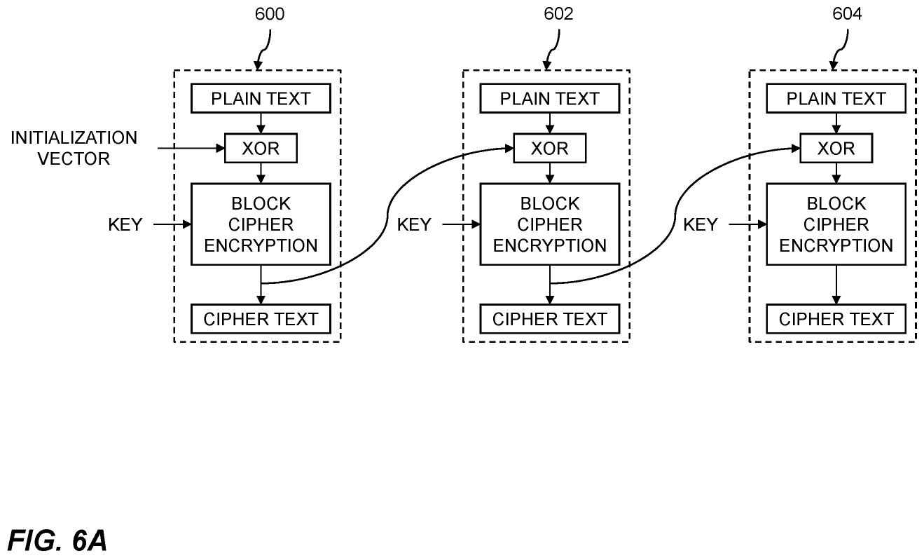

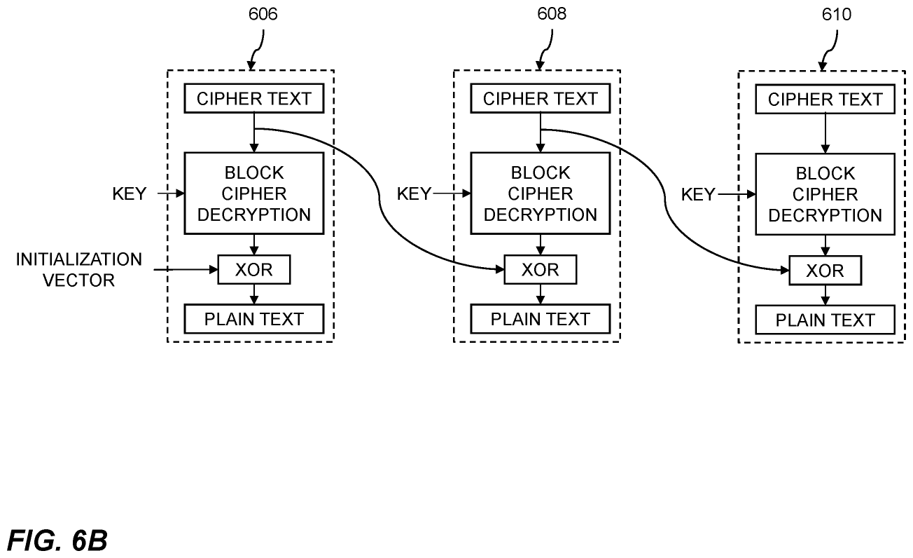

FIG. 6A illustrates cypher block chaining encryption. Online transactions can be secured by using a blockchain. Discussed throughout, a blockchain is a distributed digital ledger that supports the recording of digital transactions, such as online transactions, as a decentralized digital ledger. The online transactions can include transactions associated with an online digital competition. The digital ledger is widely distributed, where the wide distribution can include global distribution. The registered transactions are hashed and stored such that the transactions cannot be altered after the transactions have been recorded without any alterations being detected. The hashing and storing thus secures the registered transactions. Cypher block chaining encryption enables digital competition self-validation using machine learning. A neural network is used to recognize digital competition result images from a digital competition. A first user group and a second user group are subscribed to a digital competition arbitration platform that oversees the digital competition, and a digital contract is executed using a digital ledger token between the first user group and the second user group. The neural network is used to validate the result from the digital competition.

The blockchain can be used to verify the authenticity of the data and other contents of the blocks within the blockchain. The usage of a blockchain can be supported by cryptographic techniques such as a block cipher mode. A block cipher can be based on a mode of operation, where a mode of operation can be an algorithm, a code segment, an app, an application, a program, etc. The block cipher operates on a block of information, where a block includes a fixed length number of bits. If the amount of information to be operated on by the block cipher does not fully fill a block, the block can be filled out by padding and other filling techniques. If the amount of information exceeds the size of a block, then the information can be partitioned into blocks until all of the information has been allocated to the one or more blocks.

The block cipher can be based on an initialization vector (IV), where the IV can be a unique sequence of binary bits. The IV can include characteristics such as being nonrepeating, random, etc. The IV can be used to encrypt text to generate cipher texts such that the resulting cipher texts are distinct from one another, even if the IV is repeatedly applied to the same plain text, using the same key. The key can be a secret key. Returning to FIG. 6A, three blocks, 600, 602, and 604 are shown for a cipher block chain for encryption. A block for cipher block chaining encryption includes plain text, a logical XOR, block cipher encryption, and cipher text. The block cipher encryption requires a key. For the first block (root) 600 in a blockchain, an initialization vector (IV) is routed to the XOR. In subsequent blocks, such as the blocks 602 and 604, the results of the block cipher encryption of the previous block can be routed to the XOR of a given block. The results of the block cipher encryption block of 600 can be routed to the XOR of 602; the results of the block cipher encryption block of 602 can be routed to the XOR of 604; and so on. The plain text of a block, such as the block 600, is XORed with the IV. The results of the XOR are encrypted using a block cipher and a key to produce cipher text. For other blocks, such as the blocks 602 and 604, the plain text of a block is XORed with the cipher text of the previous block. The results of the XOR are encrypted using a block cipher and a key to produce the cipher text for that block. The XORing and encrypting continue for as many blocks as are required for the data.

FIG. 6B illustrates cypher block chaining decryption. A blockchain is a digital ledger that supports the recording of digital transactions such as online transactions. The blockchain records the online transactions as a decentralized digital ledger, enabling securing of the online transaction. The digital ledger is widely distributed physically, geographically, etc. The registered transactions are hashed and stored such that the transactions cannot be altered, modified, changed, corrupted, tampered with, etc., after the transactions have been recorded. The hashing and the storing enable securing the registered transactions. The registered transactions can include transactions associated with digital competition arbitration. A digital competition can be self-validated using machine learning.

Three blocks, 606, 608, and 610, are shown for cipher block chaining decryption. A block, such as any of 606, 608, or 610, for cipher block chaining decryption includes cipher text, block cipher decryption, an XOR, and plain text. The block cipher decryption is based on a key. The key can include a private key, a public key, and so on. The input to the XOR is an initialization vector (IV) for the first or root block 606. As for encryption, the inputs to XORs of subsequent blocks such as the blocks 608 and 610 are based on the cipher texts of the previous blocks. The cipher text of the block cipher decryption block 606 can be routed to the XOR of the block 608; the cipher text of the block 608 can be routed to the XOR of the block 610, and so on. The decrypting and XORing can continue for further blocks of the blockchain.

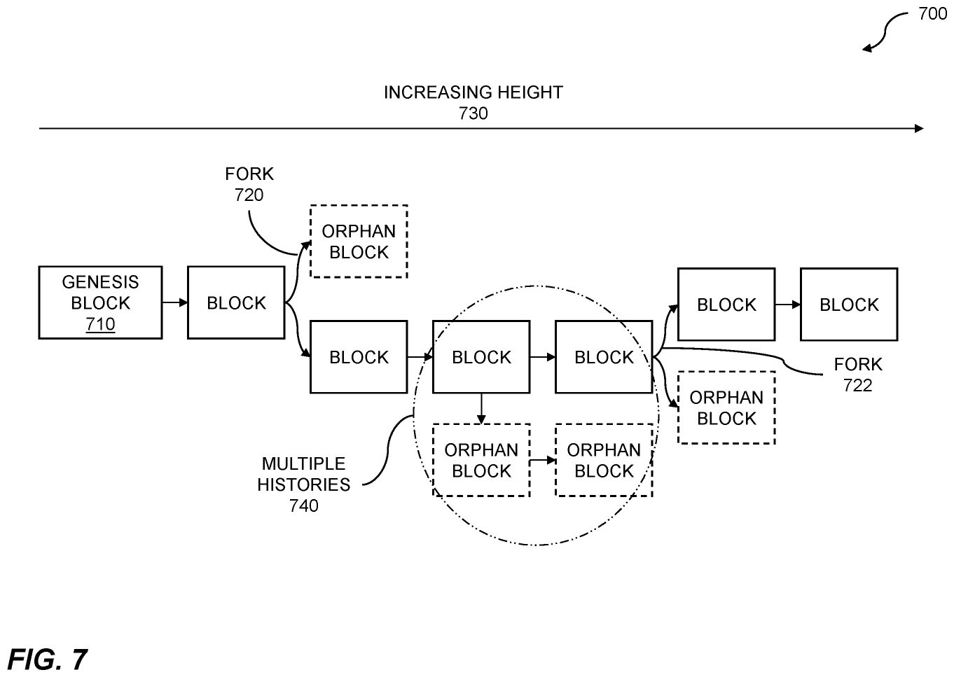

FIG. 7 shows formation of a blockchain over time. A blockchain is a digital ledger that supports the recording of digital transactions such as online transactions. Online transactions can be secured by using a blockchain, where the blockchain records the online transactions as a decentralized digital ledger. The digital ledger is widely distributed, where the wide distribution can include local, regional, national, or global distribution. The registered transactions are hashed and stored in order that the transactions cannot be tampered with. Any tampering with a registered transaction can be detected, thus the registered transactions remain secure. The formation of a blockchain over time enables digital competition self-validation using machine learning. A neural network is trained to recognize digital competition result images from a digital competition. A first computing device is used to subscribe a first user group and a second user group to a digital competition arbitration platform that oversees the digital competition. A second computing device is used to execute a digital contract using a digital ledger token between the first user group and the second user group. The digital contract pertains to a result from the digital competition. The neural network is used to validate the result from the digital competition.

The illustration 700 shows a blockchain including a genesis block 710 that forms the root of a blockchain. Blocks can be added to the blockchain over time. The addition of blocks can be described as increasing the height 730 of the blockchain. Addition of a new block to the blockchain can be based on validation. Recall that the blockchain is a distributed digital ledger. At times, validation can occur concurrently for separate blocks. The result of concurrent validation can be to create a fork such as a first fork 720 and a second fork 722, where the fork can remain temporarily. The temporary fork can result in multiple histories of the blockchain, such as multiple histories 740. The multiple histories can occur since updates to the blockchain might not have completely disseminated across the distributed digital ledger. The various versions of the histories of the blockchain are scored, as described elsewhere. The versions of history of the blockchain that score the highest can be chosen over versions of the history of the blockchain with lower scores. The lower scored versions of the history might not be selected for inclusion in the blockchain and are orphaned, as show in the illustration 700 by the orphan blocks. Decisions about which histories of the blockchain score the highest are determined by peers in the distributed digital ledger. Updates to the blockchain are distributed across the peers. A peer can receive a version of the history of the blockchain with a higher score. The higher score can be due to a block being added to the blockchain. The peer can add the new block to the version of the blockchain stored by the peer, overwrite the existing version of the blockchain, etc. A new score can be determined. The peer can retransmit the improved blockchain to their peers.

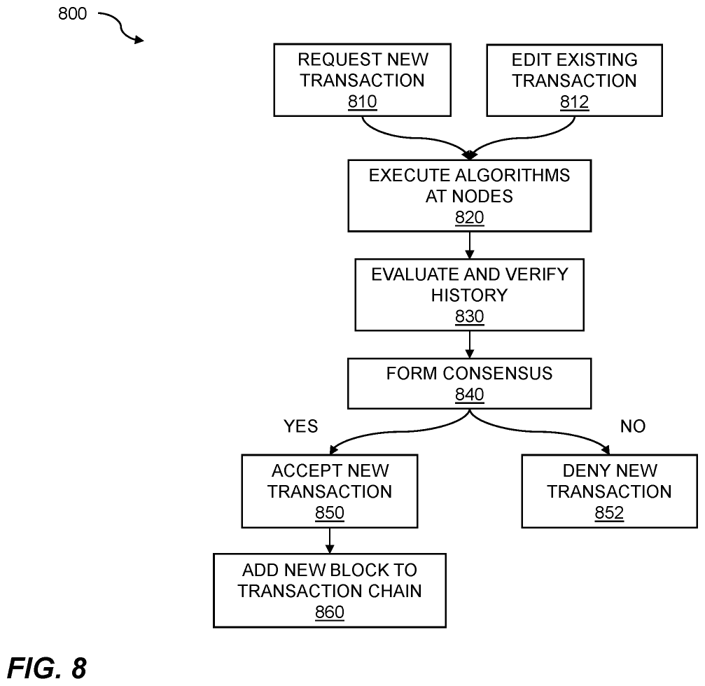

FIG. 8 is a flow diagram for transaction handling. Online transactions can be secured by using a technique such as a blockchain. A blockchain is a digital ledger that supports the recording of digital transactions. The digital transactions can include online transactions, where the online transactions can be associated with a digital competition. The blockchain records the online transactions as a decentralized digital ledger. The digital ledger is widely distributed, where the wide distribution can include global distribution. The registered transactions are hashed and stored such that the transactions cannot be altered, modified, changed, corrupted, tampered with, etc., after the transactions have been recorded, thus securing the registered transactions. The veracity of a registered transaction is authenticated based on collaboration among various systems that participate in supporting the decentralized digital ledger. The transaction handling can include handling transactions associated with digital competition arbitration. Digital competition arbitration can be used for supporting digital competition self-validation, where the self-validation can use machine learning. A neural network is trained to recognize digital competition result images from a digital competition. A first user group and a second user group are subscribed to a digital competition arbitration platform that oversees the digital competition. A digital contract is executed using a digital ledger token between the first user group and the second user group, where the digital contract pertains to a result from the digital competition. The neural network is used to validate the result from the digital competition.

To support the use of a blockchain for transactions such as financial transactions, a layer can be built on top of the blockchain. One such layer is the Omni™ Layer. The Omni™ layer includes a protocol for digital currency and communications that supports cryptocurrency transactions. The Omni™ layer can be built on the Bitcoin™ blockchain. The Omni™ layer can support financial transactions, including complex financial transitions on a cryptocurrency. The transactions can include building custom currencies and assets, crowdfunding, peer-to-peer asset trades, etc. A cryptocurrency can include Bitcoin™, Ethereum™, and so on. The complex financial transactions can include sending a cryptocurrency payment, receiving a cryptocurrency payment, transferring a cryptocurrency, auditing a transaction, and so on. The payments, receipts, transfers, etc., can be made with respect to a cryptocurrency address. The cryptocurrency address can be generated by selecting a random private key and generating a corresponding cryptocurrency address. Fees can be associated with the financial transactions and can be paid in the cryptocurrency of choice. Another example of a layer that helps support transactions using a cryptocurrency is Ethereum™ Casper™. Cryptocurrencies can run using a technique called “proof-of-work” (PoW). In a proof-of-work technique, users, called “miners”, solve one or more cryptographic puzzles to add to or “mine” a blockchain. Casper™ can use a “proof-of-stake” (PoS) technique. Proof-of-stake techniques can include consensus algorithms that can be applied to public blockchains. In a proof-of-stake technique, validators can by turns propose and vote in a next blockchain. The vote of each validator can have a weight, where the weight can be based on the financial stake of the validator. The financial stake of a validator can be based on a deposit or “stake”.

Cryptocurrencies such as Bitcoin™, Ethereum™, and so on, can be purchased and sold. As such, the value of a cryptocurrency can be based on classic market forces such as supply and demand. Given a supply of cryptocurrency units or “coins”, when demand increases, the price to purchase a unit of the cryptocurrency can also increase. When demand wanes and there is an oversupply of the cryptocurrency units, the price to purchase a unit of the cryptocurrency can also fall. Another technique is to issue units of a cryptocurrency based on deposited funds, where the deposited funds often can be based on a fiat currency. That is, a customer wishing to purchase units of a cryptocurrency can deposit United States dollars, British pounds, European Union euros, Chinese yuan, etc., and can be issued a number of cryptocurrency tokens. When the issuer of the cryptocurrency tokens exchanges only one currency, other currencies first can be converted to the one currency before cryptocurrency tokens are issued, such as converting euros to dollars. A token issuing entity can hold United States dollars in a bank account and can issue tokens based on the deposited funds. Tether™ tokens use a blockchain as a ledger and are able to move tokens among users for purchases, sales, funds transfers, and so on. Tether™ tokens can be issued on Bitcoin™ and Ethereum™ DollarToken™ can use a smart contract to control the movement of tokens among purchasers, sellers, funders, e-gamers, and so on. When a United States dollar is deposited in a bank account, DollarToken™ tokens can be issued to the user. The more dollars deposited, the more DollarToken™ tokens can be issued.

Returning to the figure, the flow 800 includes requesting a new transaction 810. A new transaction can include starting a new blockchain where the new transaction can represent the first or root block of the blockchain. The new transaction can include adding a transaction to an existing block chain. The new transaction can include adding a new block to the blockchain based on a time, such as adding a block every five minutes, for example. The new transaction can include receiving an updated block chain from a peer in a distributed digital ledger. The flow 800 includes editing an existing transaction 812. A block in the blockchain can be edited for a variety of purposes such as updating, modifying, correcting, or otherwise changing the contents of a block. A block in the blockchain could be updated to correct a data corruption event. As discussed elsewhere, editing a transaction, data, a block, etc., can require determining a new nonce value for the block that is to be edited.

The flow 800 includes executing algorithms at nodes 820. An algorithm, code segment, app, application, program, etc., can be executed at a node based on a request for a new transaction. The algorithm, code segment, etc., can be used to process data as part of a cipher chain. The flow 800 includes evaluating and verifying a history 830 of a blockchain. Recalling the discussion of a blockchain and its formation, it may be noted that a block in the blockchain includes a label or number, a nonce, data, a previous hash, and a hash generated for the current block based on the other block information. Since the hash for a block in the blockchain is computed based on the hash from the previous block, the determination of the hash for the current block is iterative. One unauthorized change in a block which occurs earlier in a blockchain invalidates not only the block in which the unauthorized change was made but also all subsequent blocks. Evaluation and verification of the history of a block can ensure the veracity of the block, the blockchain, etc.

The flow 800 includes forming a consensus 840. Each node that is included in a distributed digital ledger includes a copy of the blockchain. The nodes can be distributed geographically. Each node, having evaluated and verified the history of its copy of the blockchain, forms a score for a new transaction request. The nodes collaborate to form a consensus on whether or not to allow the transaction. The collaboration among nodes can include collective self-interest. The collaboration among the nodes can support high confidence in data security, integrity, and so on. If the consensus formed from the evaluation and verification by the nodes is “no”, then the new transaction is denied 852. If the consensus formed from the evaluation and verification by the nodes is “yes”, then the new transaction is accepted 850. The flow 800 includes adding a new block to the transaction chain 860. Adding a new block to the transaction chain includes obtaining the hash from the previous block, obtaining the transaction, data, etc. for the new block, and generating a hash for the current (new) block. The new block can then be added to the blockchain. As described elsewhere, the addition of the new block can be distributed to the peers that are included in the distributed digital ledger. The new block can be added to the blockchains at the peers, the updated blockchain can overwrite the blockchain existing at the peers, etc. Various steps in the flow 800 may be changed in order, repeated, omitted, or the like without departing from the disclosed concepts. Various embodiments of the flow 800 can be included in a computer program product embodied in a non-transitory computer readable medium that includes code executable by one or more processors.

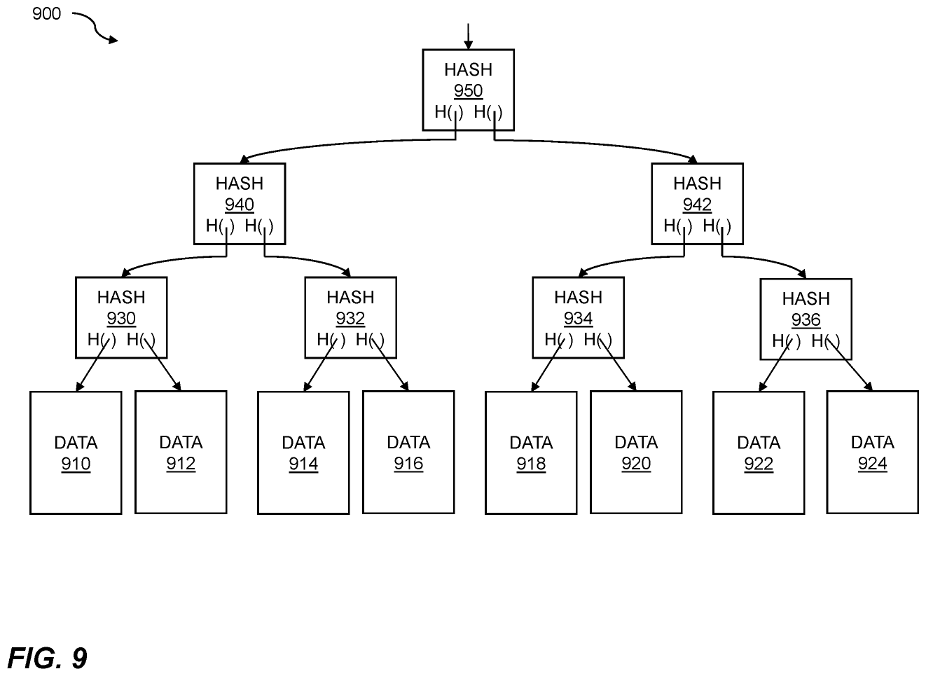

FIG. 9 shows a Merkle tree. Discussed throughout, online transactions can be secured by using a variety of techniques such as a blockchain. A blockchain can be understood to be a digital ledger that supports the recording of a wide range of digital transactions including online transactions. The blockchain records the online transactions as a widely distributed, decentralized digital ledger. The wide distribution can include regional, national, or global distribution. The registered transactions are hashed and stored before recording the transactions, thus securing the registered transactions after the transactions have been recorded. The hashing and storing ensures that the transactions cannot be altered, modified, changed, corrupted, tampered with, etc. without detection. Veracity of a registered transaction is authenticated based on collaboration among systems that support the decentralized digital ledger. The authentication is based on verifying a hashchain for the transaction. The blockchain is based on a hashchain within a hashchain. A blockchain can enable digital competition self-validation using machine learning.

A Merkle tree is based on a hash tree, where the hash tree can be a binary tree. The Merkle tree includes nodes, where the nodes include leaf nodes that can contain data, intermediate nodes, a root node, and so on. Nodes within the Merkle tree can be labeled. The labels of the nodes can be based on hashing. The label of a given node can include the hash of the labels of the child nodes of the given node. The label that is assigned to the parent node of given leaf nodes can include a hash of the contents, values, etc., contained within the leaf nodes. The hashes that are generated and are used as labels for the nodes of the Merkle tree can support verification of the data stored in the leaf nodes. The verification of the data stored in the leaf nodes can include secure techniques.

An illustration of a Merkle tree 900 is shown. The Merkle tree 900 includes leaf nodes 910, 912, 914, 916, 918, 920, 922, and 924. The leaf nodes can be hashed, where the hash technique can be based on taking data of any size and mapping that data to data of fixed size. The hash that can be generated by the hash technique can support rapid data searches, cryptography, etc. For a Merkle tree that can include a binary tree, the leaf nodes can be grouped in pairs. The hashes that are generated for each node in the pair can be used to form node labels including hashes 930, 932, 934, and 936. The labels can be based on concatenating the hashes from the leaf nodes. The hash 930 can be based on concatenating hashes for data in leaf nodes 910 and 912; the hash 932 can be based on concatenating hashes for data in leaf nodes 914 and 916; the hash 934 can be based on concatenating hashes for data in leaf nodes 918 and 920; and the hash 936 can be based on concatenating hashes for data in leaf nodes 922 and 924. Forming labels for parent nodes can include hashing and concatenating labels of intermediate (child) nodes. A label for a parent node 940 can be determined by concatenating the hash of the child node hash 930 and the hash of the child node hash 932; and the hash for parent node 942 can be determined by concatenating the hash of the child node hash 934 and the hash of the child node hash 936. The steps of hashing labels and concatenating hashes can be repeated. The label for a hash 950 can be determined by concatenating the hash of the node hash 940 and the hash of the node hash 942. Since there are no other pairs of child nodes, then the hash 950 can be a root node.

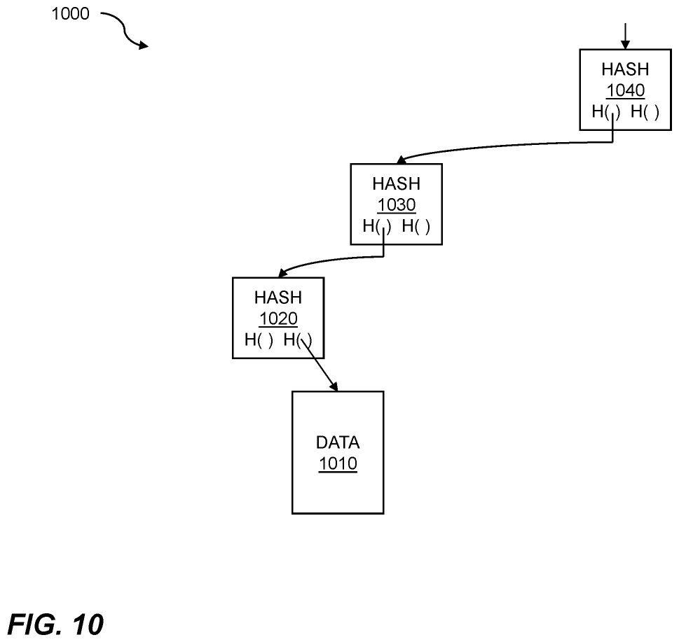

FIG. 10 illustrates proof of membership. Online transactions such as those associated with an online digital competition can be secured by using a blockchain. A blockchain is a digital ledger that supports the recording of digital transactions such as online transactions. The blockchain records the online transactions as a decentralized digital ledger. The digital ledger is widely distributed, where the wide distribution can include global distribution. The registered transactions are hashed and stored such that the transactions cannot be altered, modified, changed, corrupted, tampered with, etc., after the transactions have been recorded, thus securing the registered transactions. Veracity of a registered transaction is authenticated based on collaboration among systems that support the decentralized digital ledger. The authentication is based on verifying a hashchain for the transaction. The blockchain is based on a hashchain within a hashchain. Proof of membership enables digital competition self-validation using machine learning.

The Merkle tree described previously is based on a hash tree, where the hash tree can be a binary tree. Nodes within the Merkle tree are labeled, where the label of a parent node can be based on a concatenation of the hashes of the labels (intermediate node) or data (leaf node) of the child nodes. Since each node can include the hashes of its child nodes, the question of whether a given node is indeed a member of the Merkle tree can be determined concisely. A subset of a Merkle tree 1000 is shown. A data block 1010 at a leaf of the Merkle tree 1000 can be a possible member of the Merkle tree. To confirm whether the leaf containing data block 1010 can be a member of the Merkle tree 1000, the root block 1040, the data block 1010, and any blocks along the path between the root block 1040 and the data block 1010 can be indicated. The blocks along the path between root block 1040 and data block 1010 include blocks 1030 and 1020. The portion of the label of the parent node that refers to the hash of the child node of interest can be extracted from the label of the parent node. Each hash that is encountered along the path from the root block 1040 to the leaf node (data block 1010) can be verified. The hashes along the path (blocks 1040, 1030, 1020, and 1010) are considered to be verified if the hashes that are calculated match the hashed labels. Verification of the hashes confirms membership of data block 1010 in the Merkle tree 1000.

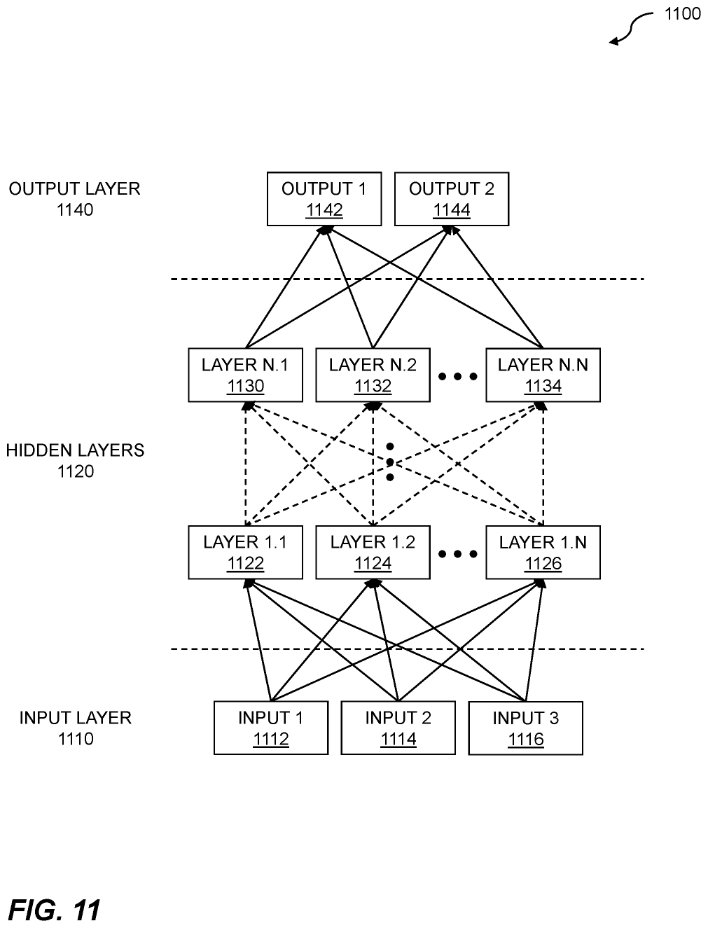

FIG. 11 shows a machine learning neural network 1100. Machine learning can be accomplished using a network such as an artificial neural network. The artificial neural network, which can include a deep neural network, a convolutional neural network, and so on, can be configured for machine learning. A neural network which has been configured for machine learning can enable digital competition self-validation. The self-validation can be used for digital competition arbitration. A neural network can be trained to recognize digital competition result images from a digital competition. A first user group and a second user group can be subscribed to a digital competition arbitration platform that oversees the digital competition. A digital contract that pertains to a result from the digital competition can be executed using a digital ledger token between the first user group and the second user group. The neural network can be used to validate the result from the digital competition.

A neural network, including a neural network configured for machine learning, is based on layers. The layers comprise nodes or “neurons”, and interconnections can be established between the layers of the neural network. The layers can include an input layer 1110, an output layer 1140, one or more hidden layers 1120, and so on. The neural network layers can include a fully connected layer, a convolutional layer, a bottleneck layer, an activation layer, a classification layer, and so on. A given neural network can include some or all of these layers, multiple layers of the same type, etc. The input layer can include one or more input nodes such as input 1 1112, input 2 1114, input 3 1116, and so on. While three input nodes are shown, other numbers of input nodes may be present. The input nodes can receive input data such as competition result data, where the competition result data can include photograph data, screenshot data, and the like. The input layer can then perform processing tasks such as identifying boundaries of a digital competition identification box or marker, user group name boundaries, watermark boundaries, and so on.

Described throughout, the neural network can include hidden layers 1120. A hidden layer can include one or more neurons, where the neurons can be connected with input layers, output layers, other hidden layers, and so on. The nodes comprising the hidden layers within 1100 can include layer 1.1 1122, layer 1.2 1124, and layer 1.N 1126. The nodes comprising the hidden layers can further comprise layer n.1 1130, layer n.2 1132, layer n.n 1134, etc. The layers among the hidden layers can be fully connected with nodes of a prior or subsequent layer, partially connected with the nodes of the prior layer of the subsequent layer, and so on. The nodes of a hidden layer can be connected to nodes within the output layer 1140. In the example 1100, the output layer can include output 1 1142 and output 2 1144. While two output nodes are shown, other numbers of output nodes can be included in the machine learning neural network.

The neural network described can be configured as a neural network for machine learning by training the neural network. A node within a layer of a neural network, whether an input layer, a hidden layer, an output layer, and so on, has one or more weights associated with it. A weight can be used to adjust the output one layer which is providing input to a further layer. The weights can be adjusted or “trained” by applying training data to the neural network. The training data comprises known input data and expected neural network output data based on the training set of input data. One or more of the weights associated with nodes within layers can be adjusted or updated during training. The assigning weights can be accomplished during a “feed-forward” pass through the neural network, during which intermediate data moves forward from the input layer nodes, through the hidden layer nodes, to the output layer nodes. Additionally, the weights can be updated during a “backpropagation” technique through the multilayered neural network. The backpropagation technique can be used to examine the outputs from the neural network and to compare those outputs to the expected outputs provided with the training data. The backpropagation enables the weights associated with the nodes within layers to be adjusted to improve neural network performance such as expediting neural network operation or improving convergence to the expected result.

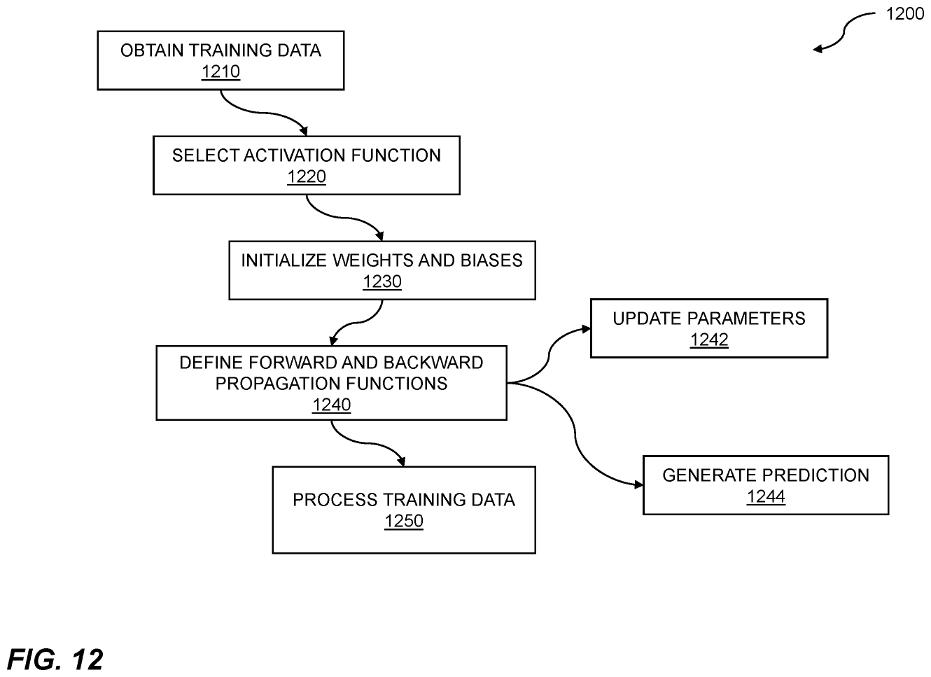

FIG. 12 is a flow diagram for machine learning training. A neural network can be configured for use in various applications including machine learning. Machine learning is based on the premise that an algorithm and/or statistical model can be developed that enables a computing device to make inferences about data. A network such as a neural network can also be used to make inferences about the data. The inferences are made without the neural network, for example, being specifically programmed to make the inferences. Instead, the neural network “learns” from training data that is provided to the neural network. Neural network training is based on techniques such as applying “known good” data to the neural network in order to adjust the neural network until it is able to attain expected results associated with the training data. The adjusting the neural network can include adjusting one or more neural network node weights, adding or removing layers such as hidden layers, etc.

In the FIG. 1200, the adjusting weights can be performed to enable applications such as digital competition arbitration. The digital competition arbitration enables digital competition self-validation using machine learning. The validating can be based on self-reporting from a first user group and a second user group, where the first user group and the second user group can engage in a digital competition. The self-reporting can be based on submitting an input image of a result of the digital competition. The input image can include a photograph, a screenshot, etc., that includes the results of the digital competition. A neural network can be trained to recognize digital competition result images from a digital competition. A first user group and a second user group can be subscribed to a digital competition arbitration platform that oversees the digital competition, and a digital contract can be executed using a digital ledger token. The digital ledger token can be executed between the first user group and the second user group. The neural network can be used to validate the result from the digital competition.

The flow 1200 includes obtaining training data 1210. The training data, which comprises known good data and expected results based on the known good data can be uploaded by a user, downloaded from a library or repository of training data, and so on. The training data can be based on data collected from previous digital competitions. The flow 1200 includes selecting an activation function 1220. An activation function, which is often non-linear, describes the output of a node based on the input to the node. The activation function can be based on a biological model, a Gaussian, a multiquadratic or inverse multiquadratic, a sigmoid, and so on. The activation function can be chosen so that the neural network can converge on a solution in the least amount of time and with the fewest layers such as hidden layers. The flow 1200 includes initializing weights and biases 1230 within the neural network that is being trained for machine learning. The weights and biases can be set to values such as non-zero values. The weights and biases can be set based on previous neural network training experience.

The flow 1200 includes defining forward and backward propagation functions 1240. A forward propagation function can be used to send or propagate values such as weights to subsequent layers within the neural network. The forward propagation can be used to add or eliminate nodes or layers, such as hidden layers, within the deep learning neural network. The backward propagation or “backpropagation” can be used to adjust weights and/or biases of previous layers and nodes to improve computational performance, to speed convergence to an inference, and so on. In the flow 1200, the defining functions can include updating parameters 1242. The parameters that can be updated can include weights or biases associated with a node, adding or deleting nodes or layers (e.g., setting weights to one or zero), and so on. In the flow 1200, the defining functions can include generating a prediction 1244. The prediction can include a predicted result based on processing of the training data by the neural network. The predicted result can be based on a classifier, a percentage, a threshold, and so on. The flow 1200 includes processing the training data 1250. The neural network processes the training data in an attempt to make a prediction about a result based on the training data. The processing the training data can include making a prediction about a result of a digital competition such as group 1 won, group 2 won, and so on. The processing of the training data can continue as training data is available for processing.

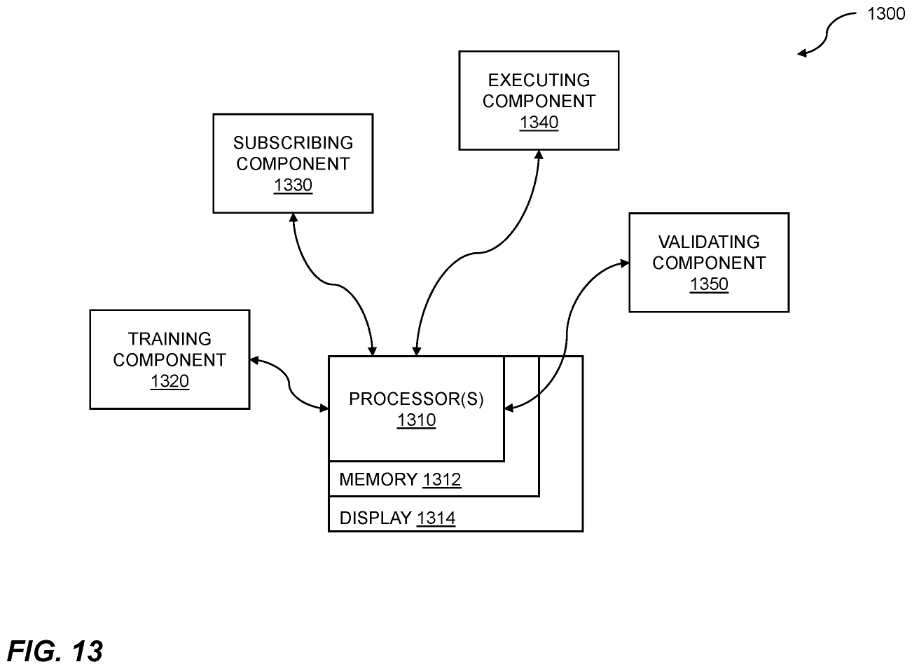

FIG. 13 is a system diagram for digital competition self-validation. Techniques including machine learning can be applied to digital competition self-validation based on analyzing images or screenshots of a digital competition. The self-validation can include digital competition arbitration. The machine learning can be accomplished by training a neural network to recognize digital competition results. The neural network can include a deep learning neural network. A system 1300 can include one or more processors 1310 connected to a memory 1312 and a display 1314. The system 1300 can include a training component 1320, a subscribing component 1330, an executing component 1340, and a validating component 1350. The system 1300 can comprise a self-validating digital competition arbitration platform. The training component 1320 can comprise training a neural network to recognize digital competition result images from a digital competition. The training can be based on applying training data, such as digital competition result images, for which a valid result has been predetermined. The training can include applying the training images and adjusting weights and layers within the neural network in order to achieve a desired level of validation accuracy. The subscribing component 1330, which can use a first computing device, can comprise subscribing a first user group and a second user group to a digital competition arbitration platform that oversees the digital competition. The competition arbitration platform can be collocated with the first user group or the second user group, and can include a central processor or server, a cloud-based server, and so on. The digital competition arbitration platform can comprise a token-based, digital smart contract. The digital competition arbitration platform can comprise a decentralized result self-verification system.

The executing component 1340, which can use a second computing device, can comprise executing a digital contract using a digital ledger token between the first user group and the second user group. The digital contract can pertain to a result from the digital competition. The validating component 1350, which can use a neural network, can comprise validating the result of the digital competition. The validating can be based on self-reporting from the first user group and the second user group. The self-reporting can be accomplished by submitting an image, where the image can include an image such as a photo of results of a digital competition, a screenshot, and the like. In embodiments, the validating can be distributed between two or more user groups. The two or more groups can include individual players, teams of players, multiple players playing simultaneously, and so on. The validating can be enabled using various techniques. Further embodiments include providing a template to at least the first user group to enable the validating. The validating component can enable self-validation of results from the digital competition. The self-validating can include at least the first user group submitting an input image of the result. The image can include a photograph of the result, a screenshot that includes the result, and so on. In embodiments, the screenshot that was taken on the device on which the digital competition for the first user group was performed can be accepted as self-validating based on both a result from the neural network and the absence of a result being submitted from the second user group. The screenshot taken of the device used by the first user group can also be accepted as self-validating, again based on the result of the neural network, and further based on a result submitted from the second group.

Disclosed embodiments include a computer system for digital competition arbitration comprising: a memory which stores instructions; one or more processors coupled to the memory wherein the one or more processors, when executing the instructions which are stored, are configured to: train a neural network to recognize digital competition result images from a digital competition; subscribe, using a first computing device, a first user group and a second user group to a digital competition arbitration platform that oversees the digital competition; execute, using a second computing device, a digital contract using a digital ledger token between the first user group and the second user group, wherein the digital contract pertains to a result from the digital competition; and validate, using the neural network that was trained, the result from the digital competition, wherein the validating is based on reporting from the first user group and the second user group.

Disclosed embodiments include a computer program product embodied in a non-transitory computer readable medium for digital competition arbitration, the computer program product comprising code which causes one or more processors to perform operations of: training a neural network to recognize digital competition result images from a digital competition; subscribing, using a first computing device, a first user group and a second user group to a digital competition arbitration platform that oversees the digital competition; executing, using a second computing device, a digital contract using a digital ledger token between the first user group and the second user group, wherein the digital contract pertains to a result from the digital competition; and validating, using the neural network that was trained, the result from the digital competition, wherein the validating is based on reporting from the first user group and the second user group.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more substeps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for digital competition arbitration comprising:
training a neural network to recognize digital competition result images from a digital competition;
subscribing, using a first computing device, a first user group and a second user group to a digital competition arbitration platform that oversees the digital competition;
executing, using a second computing device, a digital contract using a digital ledger token between the first user group and the second user group, wherein the digital contract pertains to a result from the digital competition; and
validating, using the neural network that was trained, the result from the digital competition, wherein the validating is based on reporting from the first user group and the second user group.

2. The method of claim 1 wherein the reporting from the first user group and the second user group comprises self-reporting.

3. The method of claim 1 wherein the validating is distributed between two or more user groups.

4. The method of claim 1 further comprising providing a template to at least the first user group to enable the validating.

5. The method of claim 1 wherein the first user group submits an input image of the result.

6. The method of claim 5 wherein the input image comprises a photograph of the result.

7. The method of claim 5 wherein the input image comprises a screenshot of the result.

8. The method of claim 7 wherein the screenshot is taken on a device on which the digital competition for the first user group was performed.

9. The method of claim 8 wherein the device on which the digital competition for the first user group was performed is validated based on the digital ledger.

10. The method of claim 8 wherein the screenshot that was taken on the device on which the digital competition for the first user group was performed is accepted as self-validating based on both a result from the neural network and the absence of a result being submitted from the second user group.

11. The method of claim 8 wherein the screenshot that was taken on the device on which the digital competition for the first user group was performed is accepted as self-validating based on a result from the neural network that includes a result submitted from the second user group.

12. The method of claim 8 wherein the screenshot contains specific digital competition result data for the first user group and the second user group.

13. The method of claim 12 wherein the specific digital competition result data includes one or more of digital competition identification, digital competition user group names, digital competition results, or digital competition result watermarks.

14. The method of claim 5 further comprising the second user group submitting an additional input image of the result.

15. The method of claim 14 wherein the additional input image comprises an additional screenshot of the result.

16. The method of claim 15 wherein the additional screenshot is taken on a device on which the digital competition for the second user group was performed.

17. The method of claim 16 wherein the device on which the digital competition for the second user group was performed is validated based on the digital ledger.

18-22. (canceled)

23. The method of claim 1 further comprising rewarding a user group that first submits the result for the digital competition.

24. The method of claim 1 further comprising negatively compensating a user group in the absence of submitting the result for the digital competition.

25-26. (canceled)

27. The method of claim 1 wherein the reporting from the first user group and the second user group is accomplished using reporting from a third party.

28. The method of claim 1 wherein the validating is accomplished using automatic recognition of a user interface provided by the digital competition.

29. A computer program product embodied in a non-transitory computer readable medium for digital competition arbitration, the computer program product comprising code which causes one or more processors to perform operations of:
training a neural network to recognize digital competition result images from a digital competition;
subscribing, using a first computing device, a first user group and a second user group to a digital competition arbitration platform that oversees the digital competition;
executing, using a second computing device, a digital contract using a digital ledger token between the first user group and the second user group, wherein the digital contract pertains to a result from the digital competition; and
validating, using the neural network that was trained, the result from the digital competition, wherein the validating is based on reporting from the first user group and the second user group.

30. A computer system for digital competition arbitration comprising:
a memory which stores instructions;
one or more processors coupled to the memory wherein the one or more processors, when executing the instructions which are stored, are configured to:
train a neural network to recognize digital competition result images from a digital competition;
subscribe, using a first computing device, a first user group and a second user group to a digital competition arbitration platform that oversees the digital competition;
execute, using a second computing device, a digital contract using a digital ledger token between the first user group and the second user group, wherein the digital contract pertains to a result from the digital competition; and
validate, using the neural network that was trained, the result from the digital competition, wherein the validating is based on reporting from the first user group and the second user group.
